(19) United States
(12) Patent Application Publication
(10) Pub. No.: US 2011/0303500 A1
(43) Pub. Date: Dec. 15, 2011

(54) Bistable Valve and Method for Actuating a Parking Brake System Having a Bistable Valve

(75) Inventors: Eduard HILBERER, Hockenheim (DE); Friedbert ROETHER, Cleebronn (DE)

(73) Assignee: KNORR-BREMSE Systeme fuer Nutzfahrzeuge GmbH, Muenchen (DE)

(21) Appl. No.: 13/029,772

(22) Filed: Feb. 17, 2011

Related U.S. Application Data
(63) Continuation of application No. PCT/EP2009/005997, filed on Aug. 19, 2009.

(30) Foreign Application Priority Data
Aug. 20, 2008 (DE) 10 2008 038 437.2

(51) Int. Cl. F16D 65/14; F16K 31/02

(52) U.S. Cl. 188/170; 251/129.15

(57) ABSTRACT

A bistable valve for use in a parking brake system has a self-retaining device. The self-retaining device includes a movable sliding element, a stationary latch, and a deep latching element pivotable relative to the sliding element and the latch. A method is provided for actuating the parking brake system having the bistable valve including the self-retaining device.

### CROSS-REFERENCE TO RELATED APPLICATIONS

This application is a continuation of PCT International Application No. PCT/EP2009/005997, filed Aug. 19, 2009, which claims priority under 35 U.S.C. §119 from German Patent Application No. DE 10 2008 038 437.2, filed Aug. 20, 2008, the entire disclosures of which are herein expressly incorporated by reference.

### BACKGROUND AND SUMMARY OF THE INVENTION

The invention relates to a bistable valve having a self-holding device. The invention further relates to a method for actuating a parking brake system having a bistable valve with a self-holding device.

Besides a service brake for braking the vehicle during vehicle operation, a vehicle usually has a parking brake, which is suited to securing the vehicle to prevent it from accidentally rolling away when it is parked. Before driving off, the driver has to release this parking brake again in order to allow the vehicle to be driven off again. Furthermore, a closed operating state of the parking brake should be stable, that is to say the parking brake, in the event of a defect, should not spontaneously release itself. For this purpose commercial vehicles, for example, have spring brake cylinders pre-tensioned by a spring which, in the absence of an active actuation signal for release of the parking brake, lock each of the vehicle wheels to which they are respectively assigned.

This action on the part of the parking brake affords the greatest possible vehicle safety when parking the vehicle but can have detrimental effects in vehicle operation. Should a defect, which interrupts the necessary signal for keeping the parking brake open, occur in the electronic or mechanical system controlling the parking brake system whilst underway, the parking brake will close spontaneously. The automatic braking of the vehicle occasioned by this can occur spontaneously and can be dangerous to traffic. Furthermore, the parking brake, once closed, cannot be opened again, which also makes the vehicle much harder to tow away.

This problem can be countered by making the parking brake likewise stable in the opened state. That is to say, in the event of a defect the parking brake remains in the opened state whist the vehicle is in operation. This can be achieved by way of a bistable valve, for example, which controls the parking brake. The bistable valve has two stable switching states, a first switching state being assigned to the closed parking brake and a second switching state to the opened parking brake.

The state of the art discloses various possible ways of ensuring that a valve will be bistable. For example, a permanent magnet may be moved between two stable rest positions by a magnetic field generated by an electrical pulse.

The object of the invention is to provide an alternative bistable valve which can be produced using a few, simple, components and which at the same time ensures a high reliability.

This and other objects are achieved by a bistable valve, and method of operating same in a parking brake system, having a self-holding device. The self-holding device comprises a moveable sliding element, a stationary catch, and a deep latching element rotatable in relation to the sliding element and the catch.

The bistable valve according to the invention has a self-holding device that includes a moveable sliding element, a stationary catch and a deep latching element rotatable in relation to the sliding element and the catch. The moveable sliding element and the stationary catch together with the deep latching element rotatable in relation to the sliding element and the catch together form a “ball-point pen” mechanism. This ball-point pen mechanism is naturally very unsusceptible to faults and at the same time is easy to manufacture. Here, the sliding element is moveable in its axial direction, the catch is fixed or stationary, and the deep latching element is designed to be rotatable in relation to the sliding element and the catch. The axis of rotation of the deep latching element is definable by the axial direction of movement of the sliding element.

The bistable valve preferably includes an actuating element in the form of an electrically activated magnetic coil for actuating the self-holding device. The use of an electrically activated magnetic coil for actuating the self-holding device, that is to say for the axial displacement of the moveable sliding element, is one tried and tested (highly reliable) way of activating valves.

Alternatively, the bistable valve may include an actuating element in the form of a pneumatically activated pneumatic piston for actuating the self-holding device. The use of a pneumatically activated pneumatic piston for actuating the self-holding device, that is to say for the axial displacement of the moveable sliding element, is also a tried and tested way of activating valves.

A bistable valve as described above is preferably used as part of a parking brake system for commercial vehicles.

It is especially preferred here if the bistable valve serves as a pilot control for a relay valve, which activates a spring brake cylinder assigned to the parking brake system. To open, a sufficient pressure level must act upon the spring brake cylinder of the parking brake system. In order to be able to achieve this within an acceptable time span, the valve activating the spring brake system must allow an adequate air flow rate and must therefore be of relatively large and heavy design. Pilot control of a monostable relay valve by the bistable valve, where the relay valve serves to activate the parking brake cylinder, is advantageous since the monostable relay valve is of simpler construction than the bistable valve and the adequate air flow rate can therefore be achieved for a smaller design outlay.

Alternatively however, the bistable valve may directly activate a spring brake cylinder assigned to the parking brake system. A direct activation by the bistable valve is not excluded, the direct activation to some extent economizing on the piping that would otherwise be necessary.

The method for activating a parking brake system according to the invention has a moveable sliding element of the self-holding device that is displaced in an axial direction by an actuating element. The moveable sliding element axially displaces a deep latching element rotatable in relation to the sliding element. On completion of the axial displacement by the actuating element, the rotation about the axis of displacement carries the deep latching element into the next detent position relative to a stationary catch. Two succeeding detent positions are assigned to the two stable switching states of the bistable valve. The carrying of the catch into the next detent position shifts the parking brake system into another operating state.

In this way, the advantages and special features of the parking brake system according to the invention are also translated into a method. This also applies to the particularly preferred embodiments of the inventive method specified below.

This is usefully developed in that the bistable valve activates a spring brake cylinder through the direct application of pressure. However, the bistable valve preferably serves for the indirect pilot pressure control of a spring brake cylinder via a relay valve.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of a self-holding device, which can be actuated by way of a magnetic coil;

FIG. 2 is a schematic diagram of a pneumatically actuated sliding element of a self-holding device;

FIG. 3 shows a representation explaining the operation of the self-holding device; and

FIG. 4 is a schematic drawing of an exemplary parking brake system according to the invention.

### DETAILED DESCRIPTION OF THE DRAWINGS

In the following drawings the same reference numerals denote the same or equivalent parts.

FIG. 1 shows a self-holding device 12, which can be actuated by way of a magnetic coil 20. The self-holding device 12, as shown, includes a moveable sliding element 14, which by energizing a magnetic coil 20 can be moved in an axial direction of movement 40 towards a rotatable deep latching element 18. When a toothed rim 46 arranged on the moveable sliding element 14 touches a further toothed rim 48 arranged on the rotatable deep latching element 18, the deep latching element 18 is also displaced by a lift height 44 in an axial direction by the moveable sliding element 14, thereby lifting a stationary catch from a detent position A 70 relative to the deep latching element 18. Owing to the profiles of the toothed rim 46 and the further toothed rim 48, the rotatable deep latching element 18 is also rotated about the axial direction of movement 40 in relation to the sliding element 14, which is moveable only in an axial direction, so that the stationary catch 16 now lies in an axial direction above a detent position B 72.

If the magnetic coil 20 is now deactivated, that is to say that the moveable sliding element 14 returns to its starting position, the rotatable deep latching element 18 also moves back again counter to the original axial direction of movement 40. In so doing the stationary catch 16 finally comes to rest in the detent position B 72. The self-holding device 12 is therefore switched from the original stable detent position A 70 into the new stable detent position B 72, which differ from one another by virtue of the different positioning of the deep latching element 18 in an axial direction of movement 40. This allows a valve, which with the aid of the self-holding device 12 becomes a bistable valve, to be activated by way of a connecting flange 42 on the deep latching element 18.

FIG. 2 shows a pneumatically actuated sliding element of a self-holding device. A movable sliding element 14 represented, which is supported so that it can move in an axial direction of movement 40 as part of a pneumatic piston 22, can be used, like the magnetic coil-actuated sliding element in FIG. 1, as part of a self-holding device. For this purpose, the moveable sliding element 14 again has a toothed rim 46, which is suitable for translating the axial movement of the sliding element 14 into a rotational movement of the associated deep latching element 18 (not shown). The pressure-actuated sliding element has a pressure connection 54, a venting 56, a seal 50 and a further seal 52, which allow a conventional displacement of the sliding element 14 in an axial direction of movement 40.

FIG. 3 is a representation explaining how the self-holding device works. The self-holding device represented is shown in highly schematic form and is shown as a projection along the periphery of the self-holding device into the plane of the page. For this reason, the representation can be periodically continued in a direction of movement 68. The toothed rim 46, which is arranged on the moveable sliding element, is moveable only in an axial direction, that is to say perpendicularly to the direction of movement 68. The further toothed rim 48 and the underlying profile with the two detent positions A and B, 70, 72 are arranged on the rotatable deep latching element, the direction of rotation likewise being predefined by the direction of movement 68. Furthermore, the stationary catch 16 is drawn in with the detent position A 70 as a starting position 62. The operating principle of the ball-point pen mechanism shown by way of example will be described in detail below.

Through actuation of the moveable sliding element the toothed rim 46 is moved perpendicularly to the direction of movement 68 towards the further toothed rim 48. Once the two toothed rims 46, 48 are touching one another, the toothed profiles of the toothed rim 46 and the further toothed rim 48 cause the axial movement of the toothed rim 46 to be translated both into an axial movement of the deep latching element with the further toothed rim 48 and the detent profile 58, and into a rotational movement in the direction of the direction of movement 68. In the process, the detent profile 58 is displaced both in an axial direction along the line 62 and in the direction of movement 68. This process is completed on reaching an intermediate position on a line 64, in which a further rotational movement of the deep latching element in the direction of movement 68 is no longer possible owing to the toothed profile of the two toothed rims 46, 48. The deep latching element has therefore rotated further under the stationary catch 16 in the direction of movement 68, with the result that the stationary catch 16 now lies on the line marking the intermediate position 64.

Once the actuation of the self-holding device is terminated, the toothed rim 46 moves in an axial direction back into its shown starting position. As a result the deep latching element with the further toothed rim 48 and the detent profile 58 likewise returns in an axial direction. The rotation which has already occurred in the direction of movement 68 means, however, that the catch 16 can no longer pass into the detent position A 70, but now drops along the line marked by the intermediate position 64 towards the detent position B 72, the stationary catch 16, by virtue of the detent profile 58, turning the deep latching element a fraction further in the direction of movement 68 in order to reach the limit position 66. The self-holding device is thereby switched from the detent position A 70 to the detent position B 72. A renewed actuation of the self-holding device would only repeat the process described, the self-holding device then being switched further in the direction of movement 68 from the detent position B 72 into the detent position A 70′.

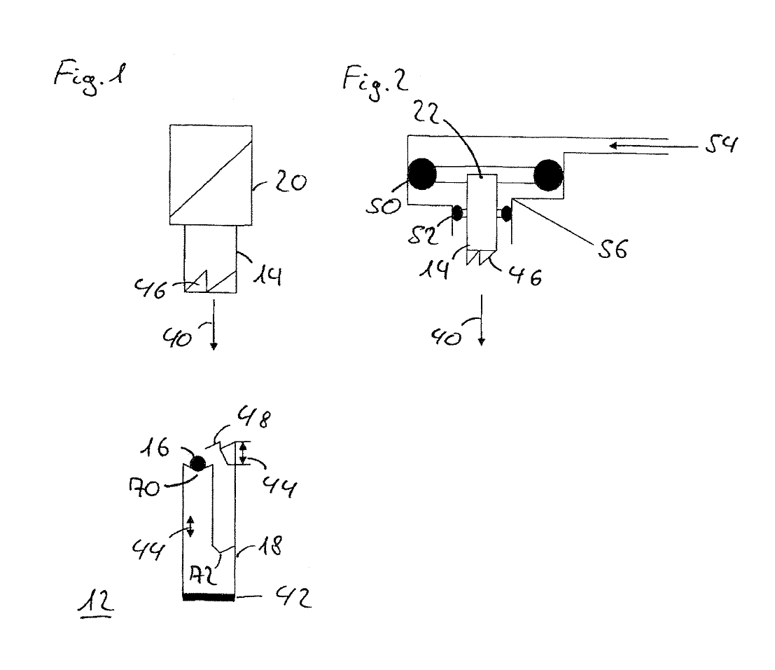

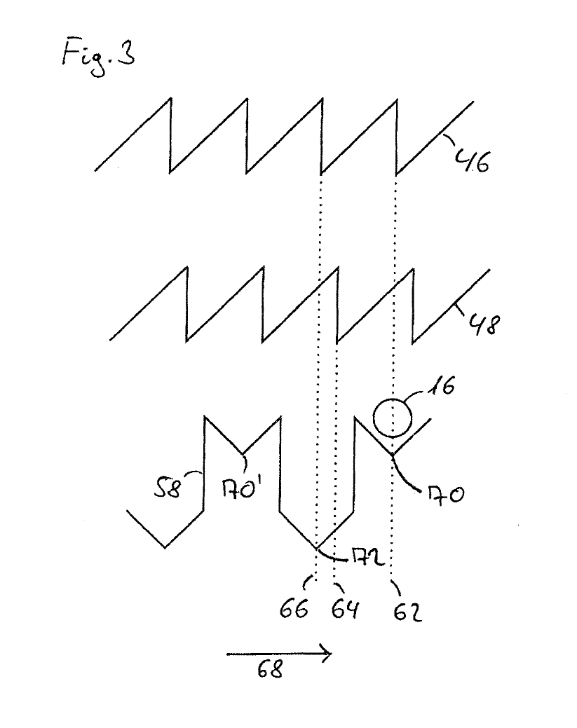

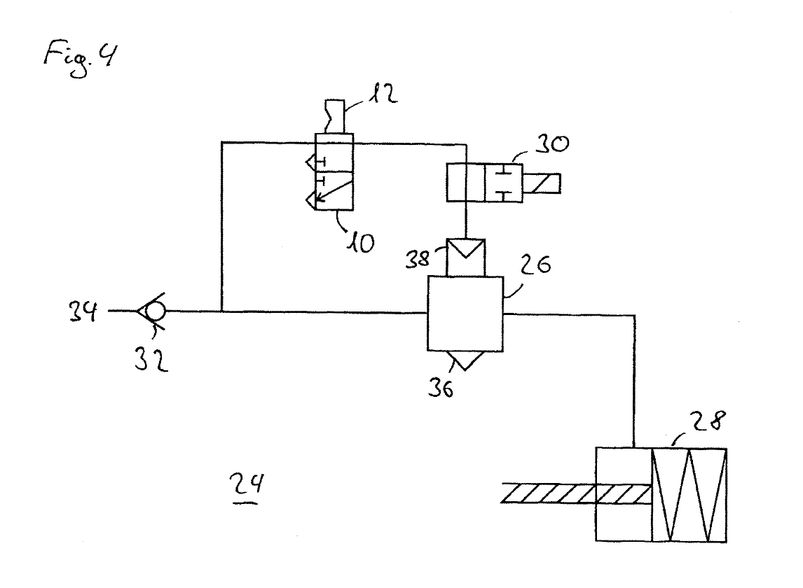

FIG. 4 illustrates an exemplary parking brake system 24. The parking brake system 24 is supplied with compressed air by a pressure supply connection 34 and includes a spring brake cylinder 28, a relay valve 26, a holding valve 30 and a bistable valve 10. The pressure supply of the relay valve 26 and the bistable valve 10 are provided downstream of a non-return valve 32. The spring brake cylinder 28 is subjected to compressed air by the relay valve 26, the relay valve 26 having its own venting 36 and being pilot-controlled by the bistable valve 10 by way of a control connection 38. The bistable valve 10 has a self-holding device 12 according to the invention, which has already been described. The holding valve 30, which is designed as a 2/2-way directional control valve and can be activated with pulse width modulation, is arranged between the bistable valve 10 and the relay valve 26. In its switching position (not shown) the holding valve 30 can maintain the pressure on the control input 38. The facility of the holding valve 30 for activation with pulse width modulation affords scope for a graduated braking action of the parking brake system 24.

Table of Reference Numerals

| | |
|---|---|
| 10 | bistable valve |
| 12 | self-holding device |
| 14 | moveable sliding element |
| 16 | stationary catch |
| 18 | rotatable deep latching element |
| 20 | magnetic coil |
| 22 | pneumatic piston |
| 24 | parking brake system |
| 26 | relay valve |
| 28 | spring brake cylinder |
| 30 | holding valve |
| 32 | non-return valve |
| 34 | pressure supply connection |
| 36 | venting |
| 38 | control input |
| 40 | axial direction of movement |
| 42 | connecting flange |
| 44 | lift height |
| 46 | toothed rim |
| 48 | further toothed rim |
| 50 | seal |
| 52 | further seal |
| 54 | pressure connection |
| 56 | venting |
| 58 | detent profile |
| 62 | starting position |
| 64 | intermediate position |
| 66 | limit position |
| 68 | direction of movement |
| 70 | detent position A |
| 72 | detent position B |
| 70′ | detent position A |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A bistable valve, comprising:
a self-holding device, the self-holding device comprising:
a moveable sliding element;
a stationary catch; and
a deep latching element rotatable in relation to the moveable sliding element and the stationary catch.

2. The bistable valve according to claim 1, further comprising an actuating element comprising an electrically activateable magnetic coil for actuating the self-holding device.

3. The bistable valve according to claim 1, further comprising an actuating element comprising a pneumatically activateable piston for actuating the self-holding device.

4. A pneumatically operable parking brake system for a commercial vehicle, comprising:
a bistable valve, the bistable valve comprising:
a self-holding device, the self-holding device comprising:
a moveable sliding element;
a stationary catch; and
a deep latching element rotatable in relation to the moveable sliding element and the stationary catch.

5. The pneumatically operable parking brake system according to claim 4, wherein the bistable valve functions as a pilot control for a relay valve, said relay valve activating a spring brake cylinder assigned to the parking brake system.

6. The pneumatically operated parking brake system according to claim 4, wherein the bistable valve directly activates a spring brake cylinder assigned to the parking brake system.

7. A method for actuating a parking brake system having a bistable valve comprising a self-holding device, the method comprising the acts of:
displacing a moveable sliding element of the self-holding device in an axial direction via an actuating element;
axially displacing with the moveable sliding element a deep latching element rotatable in relation to the moveable sliding element;
upon completing the axial displacement by the actuating element carrying the deep latching element into a next detent position relative to a stationary catch via the rotation about an axis of displacement, two succeeding detent positions being assigned to two stable switching states of the bistable valve; and
shifting the parking brake system to another operating state upon carrying the catch into the next detent position.

8. The method according to claim 7, wherein the bistable valve activates a spring brake cylinder through direct application of pressure.

9. The method according to claim 7, wherein the bistable valve provides indirect pilot pressure control of a spring brake cylinder via a relay valve.
